(19) United States
(12) Patent Application Publication
(10) Pub. No.: US 2005/0117152 A1
(43) Pub. Date: Jun. 2, 2005

(54) Optical device for simultaneous multiple measurement using polarimetry and spectrometry and method for regulating/monitoring physical-chemical and biotechnical processes using said device

(76) Inventors: Wolfgang Barnikol, Mainz (DE); Kai Zirk, Wildflicken (DE)

Correspondence Address: BANNER & WITCOFF, 1001 G STREET N W, SUITE 1100, WASHINGTON, DC, 20001, US

(21) Appl. No.: 10/240,165

(22) PCT Filed: Feb. 22, 2001
(86) PCT No.: PCT/EP01/02009

(30) Foreign Application Priority Data
Mar. 31, 2000 (DE) 10016023.9

(51) Int. Cl. G01J 4/00

(52) U.S. Cl. 356/364; 356/300

(57) ABSTRACT

The invention relates to a device, especially an optical flow-through measuring cell, for the combined use of spectrometry and polarimetry for simultaneously measuring multiple variables in physical-chemical and biotechnical processes, with multiple optical layer thicknesses at the same time. Spectrometry can be used to detect dissolved substances in the medium flowing through the cell in the ultraviolet range (UV), the visible range (light) and the near infrared range (NIR) of electromagnetic radiation, in particular.

The invention relates to a device, in particular an optical-flow-through measuring cell for the combined use of spectrometry and polarimetry for simultaneously determining multiple variables in physical-chemical and biotechnical processes. Spectrometry can be used, in particular, in the ultraviolet range (UV), the visible range (light), and the near infrared range (NIR) of electromagnetic radiation to detect dissolved substances in the medium flowing through.

In monitoring and regulating physical-chemical and biotechnical processes, for example in chemistry, pharmacy, biotechnology, environmental technology, and medicine, properties of substances in solution must often be continuously and quantitatively recorded without delay; the concentration and/or the optical activity may be the variables to be measured or recorded, among other things.

In chemical analysis as well as process regulation, such as for example, chemical conversion and the regulation of biological processes in bioreactors, properties of substances in solution (for example, the concentration and/or optical activity) must often be continuously and quantitatively recorded without delay. A principal possibility of the technical embodiment of such measuring tasks exists in the continued withdrawal and return of the material being measured, as well as a measurement in the created “bypass flow” or “measurement cycle” with the optical analytical method in the flow-through measuring cells. For certain analytical methods, for example, chromatographic methods, which always work with optically clear media, a measurement in the entire liquid medium, i.e., in the main stream (here the eluate), can also be imperative. Optical measuring devices containing the flow-through measuring cells, as well as modular flow-through measuring cells for optical measurements, have long been known and exist in great numbers with varying developments. However, these flow-through measuring cells are primarily conceived for a single, special measuring task, so that a combination of different measuring methods necessarily exists in a series connection of various measuring devices or measurement systems. As a result, it is not possible to conduct simultaneous measurements of different variables in the same sample. Moreover, liquid increments in the particular measurement sections are often clearly mixed with one another, and this results in a decrease of the separation efficiency of analytical methods, for example. A summation of such effects by adding several measurement sections is therefore very disadvantageous. There may be a further problem when the bypass flow consists of a sterile liquid (for example, from a bioreactor): The more mechanical connections there are in the measurement cycle, the greater the danger of bacterial contamination.

Moreover, it would be advantageous if the measuring cell, as well as the measuring system (electronics, radiation sources, detectors, etc.), is arranged spatially separate from one another so that it is possible to measure at variously adjustable temperatures and at the overpressure in the cell even in areas exposed to a risk of explosion and/or in areas under strong electromagnetic influence.

German Patent Application 199 11 265.7 (filing date: Mar. 13, 1999) describes a device, using polarimetry and IR spectrometry, though specifically geared for measuring the glucose concentration in tissue fluids, with no simultaneous measurement of variables being possible in a wide spectrometric and polarimetric area.

The task of the present invention, therefore, is to develop a device, in particular-a flow-through measuring cell for combined optical measurements in liquid material being measured via spectrometry and polarimetry that allow quantitative measurements practically without delay. The measurement device together with the modular units that are necessarily connected thereto on one side, as well as measuring system (electronics, radiation sources, detectors, etc.) on the other side, should preferably be arranged spatially separate from one another. As a spectrometric measuring method, the so-called UV spectrometry (wavelength range (Δλ): from 0.2 to 0.4 μm, UV: ultraviolet radiation), the light spectrometry (wavelength range (Δλ): from 0.4 to 0.8 μm), and the NIR spectrometry (wavelength range (Δλ): from 0.8 to 2.5 μm, NIR: near infrared radiation) should be applicable, that is, measurements either in one, two, or even all three wavelength ranges simultaneously and/or measurements at several wavelengths in one or all mentioned wavelength ranges. In addition, there-should be an option to set different, continuously variable optical path lengths (film thicknesses). Polarimetry should preferably be executable with light, at least with two different optical path lengths, without having to modify the cell. Moreover, it should be possible to temper the cell and to use it in overpressure operation.

The above-mentioned task is achieved, according to the invention, using a device (cell) according to the following descriptions and the (main) claim 1. Advantageous forms of embodiment are specified in the sub-claims.

The device or cell according to the invention is preferably long and provided with optical devices for guiding measuring light beams for polarimetry. A measuring light beam may run lengthwise, and/or another measuring light may run crosswise through the device, in particular the cell. The combination of lengthwise and crosswise arrangement of the polarimetric working beams is particularly preferred (devices 3.1, 3.2). The relation of the optical path lengths of the measuring beams then depends on the dimensions of the base (cell), namely the diameter (in particular, the inner diameter, for example, of the cell) in relation to the length, and is 1:1 to 1:50, preferably more than 1:1, in particular, 1:2 to 1:40 or 1:11 to 1:30, and particularly preferred, 1:2 to 1:10, in particular, 1:10. Because of the chosen difference of the optical path lengths, dissolved, optically active substances may surprisingly be measured in a large area of concentration in one and the same device (cell). All optical devices used for the polarimetrical analysis do not change the polarization state of the measuring beam.

There may be optical devices (3′) for the spectrometric measurement, together with the above mentioned combination of the polarimetric devices, e.g., crosswise to the base axis, preferably through suitable adapter receptacles, which establish the measurement sections for the spectrometric measurements. In this embodiment, their optical path lengths (thickness of layer) are thus equal to the inner diameter of the base.

It is also preferred if the polarimetric device(s) and the spectrometric device(s) are arranged crosswise to the base, e.g., if outlet connection elements are available lengthwise. The optical devices 3′ may alternatively be positioned in the longitudinal direction and optionally also in the transverse-direction, as described below, and/or arranged on adapter receptacles through guides with glass rods. This correspondingly increases the number of possible optical path lengths. The optical device(s) for polarimetry is thus arranged crosswise to the base. The arrangement of the optical devices is consequently variable and may be structured depending on the application requirement.

The device according to the invention may preferably exhibit cell windows, which in particular consist of radioparent material, for example out of quartz, which has good optical transparency for a wide range—from UV to NIR—of electromagnetic beams. The beam coupling and uncoupling may take place via conductors, in particular fiber optics, with polarized optic light guides preferably being used for the polarimetric analysis and fiber optics made of quartz preferably being used for the spectrometric analysis. A spatial separation of the signal receiver and signal processing system from the cell may consequently be achieved, in particular.

The device (cell) according to the invention for spectrometric and polarimetric optical measurements in the liquid material for measurement consequently includes a base 1, a measuring system, and optical devices, with an optical device being arranged to guide the polarimetric measuring light lengthwise to the base and an optical device being arranged to guide the polarimetric measuring light crosswise to the base, as well as one or several other optical devices to lead spectrometric working beams lengthwise and/or crosswise to the base.

An optical device includes two identical parts, each of which, for example, exhibits a collimator and/or focuser and/or optical neutral filter and/or optical interference filter and/or polarizer. These are known mechanisms for optical devices, as described, for example, in the NAUMANN SCHRÖDER book, Bauelemente der Optik [Optical Elements].

The measuring system includes, in particular, the electronics, radiation sources, signal processing systems, and detectors.

The optical devices are preferably connected with the measuring system via conductors, in particular via polarized fiber optic light guides for polarimetry, and via fiber optics for spectrometry. A spatial separation of measuring system and base is consequently achieved with the corresponding advantages.

It is furthermore preferred for the base 1 or the device to contain a measuring body 2, in particular a tubular profile measuring body, preferably out of a material radioparent for measuring, preferably out of quartz. Alternatively, a glass tube may also be chosen.

The measuring body, in particular the tubular profile measuring body (profile measurement tube), may exhibit a round cross section 2-with two plane-parallel surfaces in a lengthwise direction on the outer sides or a square cross section 11 or another suitable shape, such as a polygon.

In particular, the optical devices for the spectrometric devices 3′ may be arranged via adapter receptacles 6, 6′ thus at least 1×2, and altogether as many as there are optical devices present, preferably 1 to 10, thus 1×2 to 1×10 adapter receptacles. The adapter receptacles thus represent, for example, guide bushs with cylindrical cross section. The number of optical devices depends on the dimension of the base, in particular, its length.

It is also preferred for the adapter receptacles 6, 6′ to be arranged parallel to the surface normals of the plane-parallel surfaces of the measuring body 2 or of the square measuring body 11.

Alternatively, the adapter receptacle(s) 6, 6′ for accommodating the spectrometric measurement beams can be situated on glass rods 16 over guides 15, whereby in particular the the rods 16 being of a material radioparent for measuring, such as quartz. In this arrangement, crosswise to the base, the optical path length (thickness of layer d) is changeable in a continuously variable manner for the spectrometric measurement in the range of 0 mm up to the inner diameter of the base. In particular, the guides are liquid-tight and the glass rods hold the adapter receptacles at one end and rise up at the other end into the graduated tube.

In the device according to the invention, the base 1 and the measuring body 2 or 11 may be designed as a reciprocally exchangeable module 14. The modules are advantageously of different lengths so that different optical lengths of path are possible for polarimetry in a lengthwise direction.

It is also preferred for the rotational axis of the optical device 3.1 to be arranged parallel to the surface normals of the front surfaces of the base structure 1. The devices 3.2 as well as the devices 3′ are preferably arranged crosswise, in particular vertical thereto. Alternatively, angles may also not be equal to 0°(based on the surface normals), insofar as optically and physically possible within the bounds. The device according to the present invention may exhibit optical devices, in particular to guide spectrometric measurement beams in the wavelength range from UV to NIR, and preferably devices to guide polarimetric measurement beams in the visible spectral range.

Furthermore, the base 1 and the measuring body 2, 11, in particular, may at each end exhibit a (cell-)closing component 7. This may exhibit the inlet or outlet connection elements 5, preferably on the side. Alternatively, the connection elements 5 may also be arranged in a lengthwise direction. The optical devices are then arranged crosswise for polarimetry as well as for spectrometry.

Moreover, one or several optical (cell-)window(s) 4 may be put in the (cell-)closing component 7, the window having a rotational axis congruent to the rotational axis of the (cell-)closing component. The (cell-)window(s) is/are preferably made of a material radioparent for measuring, such as quartz.

An optical device for polarimetry 3.1 placed in the (cell-)closing component 7 is preferred, the rotational axis of the optical device being congruent to the rotational axis of the (cell-)closing component.

Furthermore, the guides 17 may be congruent to the rods 18 or be incorporated around the rotational axis of a (cell-)closing component 7, which is arranged at each end of the base 1 and of the measuring body 2.

These glass rods 18 as well as the above-mentioned glass rods 16 preferably made of a material radioparent for measuring, such as quartz, and adjustable to one another with a radiopaque outer surface. As mentioned, adapter receptacles for spectrometric devices 3′ may be arranged on these glass rods. This allows the optical path length to be changed in a lengthwise direction in a continuously variable manner for the spectrometric measurement. In such an arrangement, the spectrometric device is in a lengthwise direction, and if necessary, in a crosswise direction, and the polarimetric device is in a crosswise direction to the base.

It is furthermore preferred for the base 1 and the measuring body 2 or 11 to exhibit a (cell-)closing component 7 at each end and for an inlet or outlet connection element 5 to be incorporated into the front of the (cell-)closing component 7.

In this embodiment, the optical devices are situated in the transverse direction. The configuration of the other parts, such as adapted receptacles, guides, modules, etc. is similar to that described above.

As mentioned, it is particularly preferred for the optical devices, particularly 3.1 and 3.2, for polarimetry to be linked to the measuring system via an optic light guide 8. The optic light guides 8 are preferably connected to the device via couplers 9.

The optical device for the spectrometric measurement, particularly 3′, may preferably be connected directly to the measuring system via conductors, in particular fiber optics 10, which are in particular made of a material radioparent for measuring, such as quartz. A spatial separation between the measurement device and the measurement system is consequently possible, the measurement system including electronics, radiation sources, signal processing systems, and detectors, such as a generally known polarimeter or spectrometer.

Especially articularly preferred is a device in which the measurement body, in particular, the profile measurement body, exhibits dimensions of no more than a 15 mm diameter, in particular, 0.5 to 12 mm, and a length of 1 to 750 mm, in particular, 300 mm, for example.

The base 1 of the device according to the invention may furthermore be equipped with one or two lateral tempering units 12, or alternatively, with one or several tempering channels 13. The device according to the present invention is thus temperable, in particular, and also usable even in overpressure, with measurements being simultaneously possible in different wavelength ranges, in particular, in a continuously variable manner.

The device according to the invention is thus suitable, in particular, for controlling and monitoring physical-chemical processes, such as chromatographys and purification of stereospecific substances as well as biotechnical processes, such as bioreactors, by coupling the device in a suitable manner with the process to be monitored or regulated. This may take place through a process control center, for example.

The previously described features and advantages of the invention are illustrated using the following detailed description of the attached drawings. Shown are:

FIG. 1, A schematic representation of an embodiment of a device according to the invention

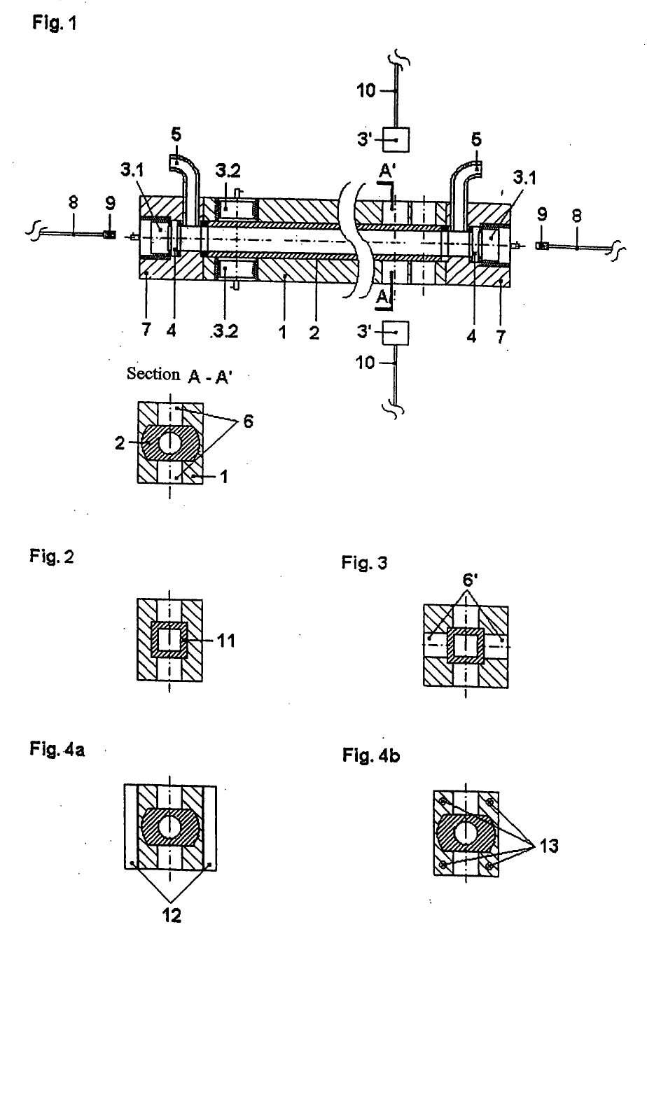

FIG. 2, A schematic representation of another embodiment of the measuring body 2

FIG. 3 a schematic representation of another embodiment of the base structure 1

FIG. 4, a schematic representation of another embodiment of the base structure 1

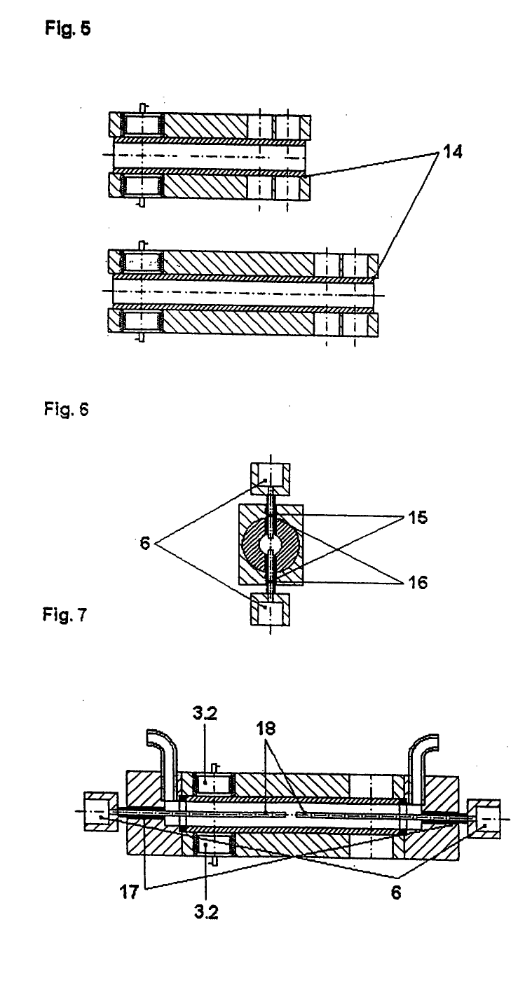

FIG. 5, a schematic representation of another embodiment of the device according to the invention

FIG. 6, a schematic representation of another embodiment of the device according to the invention

FIG. 7, a schematic representation of another embodiment of the device according to the invention

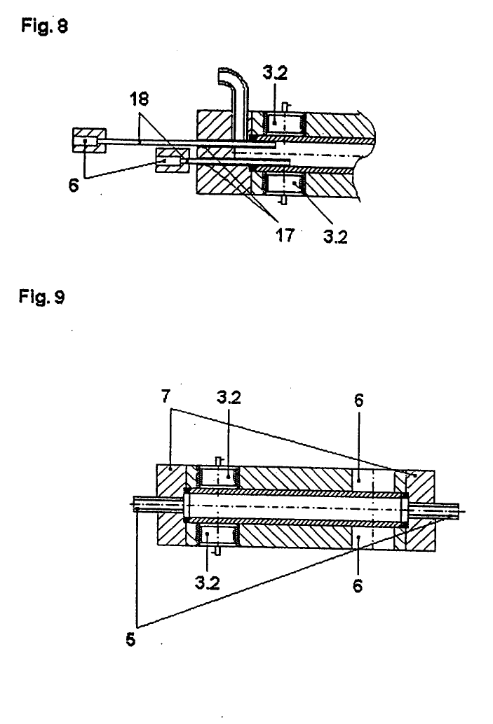

FIG. 8, a schematic representation of another embodiment possibility of the (cell-)closing component 7

FIG. 9, a schematic representation of another embodiment of the device according to the invention.

FIG. 1 shows the profile of an example of the device according to the invention (flow-through measuring cell). It essentially consists of a base 1, which here surrounds a tubular profile measuring body 2 made of quartz. This round measuring body has two plane-parallel surfaces (spanner opening) in a lengthwise direction on the outside, whose surface normals are parallel to the rotational axis of the adapter receptacles 6 (Section A-A′) and to the rotational axis of the optical devices 3.2 for polarimetry to be carried out crosswise. There are as many adapter receptacles as the length of the structure allows. The base is provided with closing components 7 at the axial ends. An inlet or outlet connection element 5 each are incorporated into these on the sides. The rotational axis of the closing component (cell closing component), the rotational axis of the optical cell window 4, and the rotational axis of the optical devices 3.1 for polarimetry in a lengthwise direction are congruent. The coupling or uncoupling of the measurement light for polarimetry takes place via the polarization-receiving glass optic light guides 8, which may be connected directly to the cell via couplings 9. The coupling or decoupling of the measuring beam for spectrometry takes place via fiber optics 10 made of quartz, whose ends are directly connected with the optical devices 3′ for the spectrometric analysis, which may be introduced into the adapter receptacles.

FIG. 2 shows a design of the measuring body similar to that in FIG. 1, but in which the profile measurement body 11 made of quartz has a square cross section instead of the previously described. The optical path length (film thickness) here is constant over the entire beam width.

FIG. 3 shows a design similar to that in FIG. 1, but in which the profile measurement body 11 made of quartz has a square cross section, and there are other adapter receptacles 6′ for optical devices for the spectrometric analysis in the base that are perpendicular to the adapter receptacles 6 (Section A-A′) in FIG. 1. The number of adapters, and consequently, the number of the “measuring” wavelengths, may be increased in this manner.

FIG. 4a shows a design similar to that in FIG. 1, but in which the base is connected to a tempering unit 12 (e.g., Peltier elements) on one or on both sides.

FIG. 4b: instead of the Peltier elements, channels 13 may run in the base, through which a tempered medium flows so that the device (cell) may be brought to a desired temperature.

FIG. 5 shows embodiments similar to that in FIG. 1, but in which the base 1 and measuring body 2 are combined in a “module” 14 and are replaceable, so that different optical path lengths, in a lengthwise direction for polarimetry may be realized.

FIG. 6 shows a design similar to that in FIG. 1, but in which the optical path length (film thickness d) is more or less changeable in a continuously variable manner in a certain range (0 mm up to the inner diameter of the measurement body). Liquid-tight guides 15 for glass rods 16 have been incorporated perpendicularly into the base 1 and into the profile measuring body 2, instead of the two opposing adapter receptacles 6 for optical devices for the spectrometric analysis. In a preferred embodiment, the rods are made of quartz. The rods are movable against each other with a radiopaque outer surface. Placed on the outer end of each rod is an adapter receptacle 6 for the optical device.

FIG. 7 shows a design similar to that in FIG. 1, but in which the optical path length (film thickness d) for the spectrometric analysis is more or less changeable in a continuously variable manner in an enhanced range (0 mm up to the length of the measuring body). Instead of the two optical devices 3.1 for polarimetry in a lengthwise direction, liquid-tight guides 17 for glass rods 18 are incorporated lengthwise to the base structure 1. In a preferred embodiment, the rods are made of quartz. The rods are movable against each other with a radiopaque outer surfaces. Placed on the outer end of each rod is an adapter receptacle 6 for the optical device for the spectrometric analysis.

FIG. 8 shows a design similar to that in FIG. 7, but in which several guides 17 for glass rods 18 are incorporated. The number of the “measuring” wavelengths can thus be increased.

FIG. 9 shows a design similar to that in FIG. 1, but in which the optical devices 3.1 for polarimetry in a lengthwise direction, as well as the guides 17 for the glass rods 18 (as per FIG. 7), are missing. Instead, the inlet or outlet connection element 5, congruent to the rotational axis of the (cell closing) component 7.

1-32. (canceled)

33. A flow-through measuring cell having an oblong measuring body (2) and a base structure (1) surrounding the measuring body (2) in a lengthwise direction, wherein the base structure (1) comprises an inlet connection element and an outlet connection element for the liquid to be measured and liquid-tight guides (17) on both longitudinal ends of the base structure (1) for one or more rods (16) extending crosswise or lengthwise to the base structure (1) and to the measuring body (2), for providing a continuously variable optical path length.

34. The flow-through measuring cell according to claim 1, in which the measuring body (2) is made of a transparent material for measuring.

35. The flow-through measuring cell according to claim 1, in which the measuring body (2) exhibits a round cross section with two plane-parallel surfaces in a lengthwise direction on the outer sides.

36. The flow-through measuring cell according to claim 1, in which the measurement body (2) exhibits a square cross section (11).

37. The flow-through measuring cell according to claim 1, in which the base structure (1) exhibits adapter receptacles (6, 6′).

38. The flow-through measuring cell according to claim 1, in which the base structure (1) and the measuring body (2) are designed together as a reciprocal, exchangeable module (14).

39. The flow-through measuring cell according to claim 1, in which the base structure (1) and the measuring body (2) at each end exhibit a closing component (7).

40. The flow-through measuring cell according to claim 7, in which one or more optical windows (4) are placed in the closing component.

41. The flow-through measuring cell according to claim 1, in which the base structure (1) is equipped with one or several tempering units (12).

42. The flow-through measuring cell according to claim 1, in which the base structure (1) exhibits one or several tempering channels (13).

43. The use of a flow-through measuring cell according to claim 1 for regulating and monitoring physical-chemical and biotechnical processes.

44. The flow-through measuring cell according to claim 2, in which the measuring body (2) exhibits a round cross section with two plane-parallel surfaces in a lengthwise direction on the outer sides.

45. The flow-through measuring cell according to claim 2, in which the measuring body (2) exhibits a square cross section (11).

46. The flow-through measuring cell according to claim 2, in which the base structure (1) exhibits adapter receptacles (6, 6′).

47. The flow-through measuring cell according to claim 3, in which the base structure (1) exhibits adapter receptacles (6, 6′).

48. The flow-through measuring cell according to claim 2, in which the base structure (1) and the measuring body (2) are designed together as a reciprocal, exchangeable module (14).

49. The flow-through measuring cell according to claim 3, in which the base structure (1) and the measuring body (2) are designed together as a reciprocal, exchangeable module (14).

50. The flow-through measuring cell according to claim 2, in which the base structure (1) and the measuring body (2) at each end exhibit a closing component (7).

51. The flow-through measuring cell according to claim 2, in which the base structure (1) is equipped with one or several tempering units (12).

52. The flow-through measuring cell according to claim 2, in which the base structure (1) exhibits one or several tempering channels (13).
